(19) United States
(12) Patent Application Publication
(10) Pub. No.: US 2012/0323545 A1
(43) Pub. Date: Dec. 20, 2012

(54) DEVICE FOR PLANNING A TRANSCATHETER AORTIC VALVE IMPLANTATION

(75) Inventors: Peter Aulbach, Forchheim-Kersbach (DE); Dominik Bernhardt, Hausen (DE); Fernando Vega-Higuera, Erlangen (DE)

(73) Assignee: Siemens Aktiengesellschaft, Munich (DE)

(21) Appl. No.: 13/523,925

(22) Filed: Jun. 15, 2012

(30) Foreign Application Priority Data
Jun. 17, 2011 (DE) 102011077753.9

(51) Int. Cl. G06G 7/48

(52) U.S. Cl. 703/11

(57) ABSTRACT

A device for planning a transcatheter aortic valve implantation is disclosed. The device includes a segmentation module for segmenting the aorta ascendens with the aorta annulus, the aortic valves and the coronary ostia as well as the left ventricle; a determination module, which determines on the basis of the segmented data the aorta annulus plane and from this one or more angiography projections for setting an angiography device, with which the aorta annulus and the coronary ostia are able to be detected in the optimum manner for positioning the transcatheter heart valve; and an output module that outputs this information. The proposed device supports the user in the planning of a transcatheter aortic valve implantation.

### PRIORITY STATEMENT

The present application hereby claims priority under 35 U.S.C. §119 to German patent application number DE 10 2011 077 753.9 filed Jun. 17, 2011, the entire contents of which are hereby incorporated herein by reference.

### FIELD

At least one embodiment of the present invention generally relates to a device for planning a Transcatheter Aortic Valve Implantation (TAVI) in which a transcatheter heart valve is introduced with a catheter into a vessel and is guided via the vessel to the implantation location, the aorta annulus.

### BACKGROUND

Transcatheter aortic valve implantation is now an established therapeutic solution in which an artificial heart valve is inserted in the patient with a catheter via the aorta femoralis and aortic arch. The transcatheter heart valves mostly used nowadays include a balloon expandable stent with an integrated biological heart valve prosthesis. The transcatheter heart valve is as a rule introduced with a catheter via the femoral artery and is advanced under x-ray control to the native aortic valve, moved into position via the aortic arch and inserted by inflating the balloon under rapid stimulation.

Such an intervention requires careful planning, in order on the one hand to determine the appropriate transcatheter heart valve for the respective geometric circumstances. Volume datasets of the heart are generated and evaluated for this purpose as a rule by means of Magnetic Resonance Tomography (MRT), Trans Esophageal Echo (TEE) or Computed Tomography (CT), in order to obtain the required geometrical data at the implantation location for determining the suitable heart valve. Measuring the different parameters is time-consuming and can currently only be carried out by highly specialized personnel. On the other hand, for x-ray control of the implantation, the user must correctly set the angulation of the C-arm of the C-arm device used for the purpose in order to see the implantation location during the implantation from the correct angle. This setting too demands a large amount of time.

### SUMMARY

A device is disclosed for planning a transcatheter aortic valve implantation which supports the user during planning.

Advantageous embodiments of the device are the object of the dependent claims or can be found in the description given below as well as in the example embodiment.

An embodiment of the proposed device for planning a transcatheter aortic valve implantation includes at least a segmentation module to, from at least one volume dataset of the heart which was recorded with an imaging method, segment data of at least the left ventricle, the aorta ascendens with aorta annulus, aortic valves and coronary ostia of the heart; a determination module to determine, from the segmented data, the aorta annulus plane and to establish, from the determination, one or more angiography projections for setting an angiography device, with which the aorta annulus and the coronary ostia are detectable in a manner for a positioning of the transcatheter heart valve; and an output module to output at least one of the following for setting the angiography device the one or more angiography projections established by the determination module, angulations, and setting data derived therefrom.

### BRIEF DESCRIPTION OF THE DRAWINGS

The proposed device is explained again in detail below on the basis of an example embodiment in conjunction with the drawings, in which:

FIG. 1 shows a schematic presentation of a sectional diagram through the heart in which the aorta ascendens with the aorta annulus and the left ventricle can be seen,

FIG. 2 shows a schematic diagram of the aorta annulus with the coronary ostia,

FIG. 3 shows a schematic diagram of a part of the aorta with the diameters relevant for planning,

FIG. 4 shows a schematic diagram for determining the angle of the coronary ostia to one another, and

FIG. 5 shows an example of the setting of a C-arm device.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The proposed device for planning a transcatheter aortic valve implantation includes at least one segmentation module, a determination module and also an output module. The segmentation module is embodied so that, from at least one volume dataset of the heart which has been recorded with a medical imaging method, it segments at least the left ventricle and also the aorta ascendens with aorta annulus, aortic valves and coronary ostia. The volume dataset can for example be a dataset recorded by way of MRT, by means of Trans-Esophageal Echo or by means of CT angiography. Preferably a volume dataset recorded by way of CT angiography with added contrast media is used. The aorta ascendens and the left ventricle can be segmented with known segmentation techniques. Preferably a technique as is known from US 2010/0240996 A1 (the entire contents of which is hereby incorporated herein by reference) is used and with which an image of the heart anatomy around the aortic valve can be created.

The determination module then determines the aorta annulus plane from the segmented data or from a model obtained therefrom and determines from this one or more angiography projections for setting an angiography device, with which the aorta annulus and the coronary ostia can be detected in the optimum manner with the same support of the patient in the later imaging accompanying implantation for the positioning of the transcatheter heart valve. The output module then outputs the determined angiography projections or the associated angulations or setting data for the angiography device employed, especially a C-arm x-ray device, with which the angiography device can later be set accordingly. An angiography projection is characterized in this case by the spatial orientation and position of the projection axis of the angiography device, i.e. the central connecting axis between x-ray tube and x-ray detector of the angiography device. The angiography projections are selected by the determination module so that this connecting axis lies perpendicular to the aorta annulus plane.

This does away with the time-consuming search user for the for the correct setting of the angiography device in subsequent imaging during the implantation. This imaging is also undertaken, using the previously determined setting, at the optimum angle of projection at which the implantation of the heart valve can best be followed.

Preferably the determination module also determines the geometrical values required for determining a suitable transcatheter heart valve on the basis of the anatomical location. These values involve at least the effective diameter of the aorta in the aorta annulus plane and the perpendicular distances from the lower edges of the coronary ostia to the aorta annulus plane. The effective diameter is to be understood in this case as the diameter of a circle, calculated from the circumference of the aorta annulus, which has this circumference. As an alternative or in addition to the effective diameter, the minimum and maximum diameter of the aorta in the aorta annulus plane can be determined by the determination module. Optionally the diameter in the widest area of the sinus valsalvae, in the area of the sinotubular junction and in the widest area of the aorta ascendens can be determined. The determination module then transfers these values to the output module, which then outputs the values and/or designations of transcatheter heart valves determined by the determination module which are suitable for an implantation based on the specific values.

With this embodiment of the proposed device even inexperienced users can carry out complex planning, since all required values for the determination or choice of the suitable transcatheter heart valve for the implantation are determined in an automated manner from the image data of the volume dataset. The automation does away with time-consuming manual measurement of the corresponding diameters and distances.

In an advantageous embodiment of the device the determination module is embodied so that as a further value it determines an angle under which the center lines between the two coronary ostia are in parallel to the projection plane. The knowledge of this angle is helpful during the later intervention for implantation of the transcatheter heart valve in order to insert the heart valve in the correct orientation (as regards a rotation around the vertical axis).

In a further advantageous embodiment, for multiphase volume datasets of the heart, the determination module determines over the entire heart cycle in each case the effective and/or minimum or maximum diameter of the aorta at the points given above. This also applies for the minimum, maximum and mean perpendicular distances from the lower edges of the coronary ostia to the aorta annulus plane. In this way the changes of the corresponding diameters and distances caused by the heart movement can be taken into consideration in the planning or determination of the suitable heart valve.

The device preferably also has an interrogation module which has access to one or more databases in which available transcatheter heart valves with their specifications, especially geometric dimensions, are entered. The interrogation module then compares the values determined by the determination module with the specifications in the database or databases and selects transcatheter heart valves of which the specifications match the values determined by the determination module. The designations of these transcatheter heart valves are then passed to the output module and output by the latter to a user. The one or more databases can in this case be a component of the device itself or can be reached by the interrogation module via a network access, for example over the Internet.

In a further advantageous developments of the device has a visualization module, which calculates a filet view presentation of the aorta annulus with the coronary ostia and presents it on a screen. Such filet views are known for example from the field of colonoscopy. In this case a presentation of the inner wall of the aorta created by means of surface or volume rendering is unwound onto one plane and display accordingly. With multiphase datasets this is done for each individual volume dataset the heart phase, with the individual views then being played on the screen in a time sequence in accordance with a video mode. In addition the points and/or the diameter lines and distance lines at which the determination module has undertaken the determination of the corresponding values can be shown in the corresponding diagrams. This gives the user an easy-to-understand presentation of the situation at the location of the planned implantation.

In the present example the present device will be described on the basis of an example embodiment, in which a pre-operative automated planning of the transcatheter aortic valve implantation based on CT data is undertaken. The geometrical data required for the determination of a suitable heart valve is determined automatically from the CT volume dataset or the CT volume datasets (with multiphase imaging).

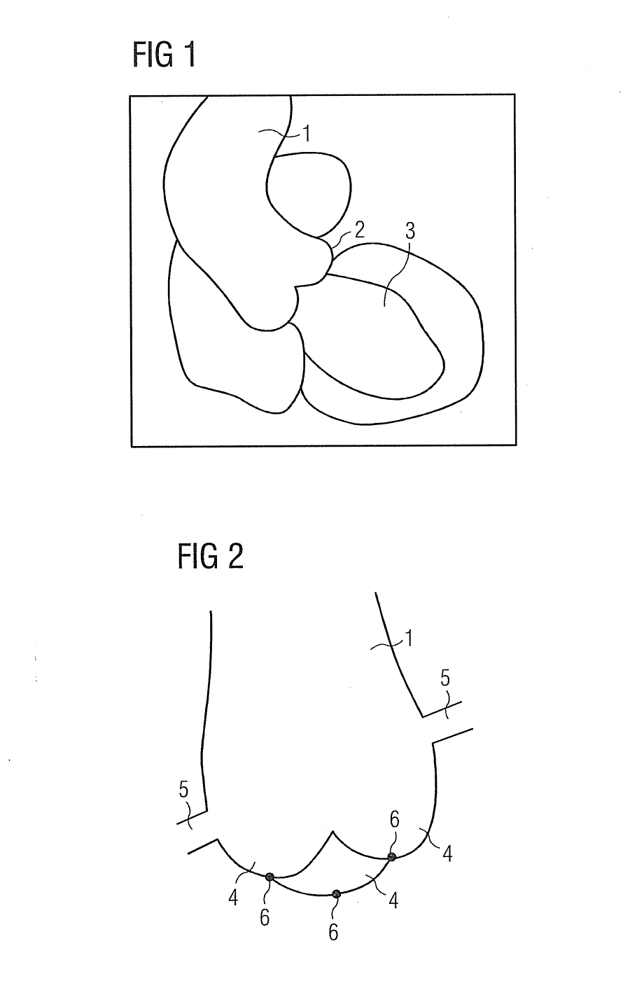

To this end FIG. 1 shows an example of a sectional plane of a CT volume dataset in which the heart can be seen in cross-section (longitudinal axis) with aorta ascendens 1, aorta annulus 2 and left ventricle 3.

FIG. 2 shows the aorta in section with the aortic valves 4 and the two exits itself the coronary vessels, i.e. the coronary ostia 5. The exit (ostium) which is closest to the aortic valve determines the maximum height (length of the valve stent collar) of the artificial heart valve. This height is predetermined in the upwards direction by the two coronary ostia. The distance is determined in the determination module of the proposed device by dropping the perpendicular from the lower edge of the respective coronary ostia onto the aorta annulus plane, which is spanned by the three points 6 indicated in FIG. 2, the lowest boundaries of the aortic valves. Since during the heart movement the aorta annulus 2 as well as the aorta ascendens 1 constantly deform by contraction and dilation, these distances likewise change depending on the heart phase. Therefore the determination module preferably determines these values from multiphase datasets.

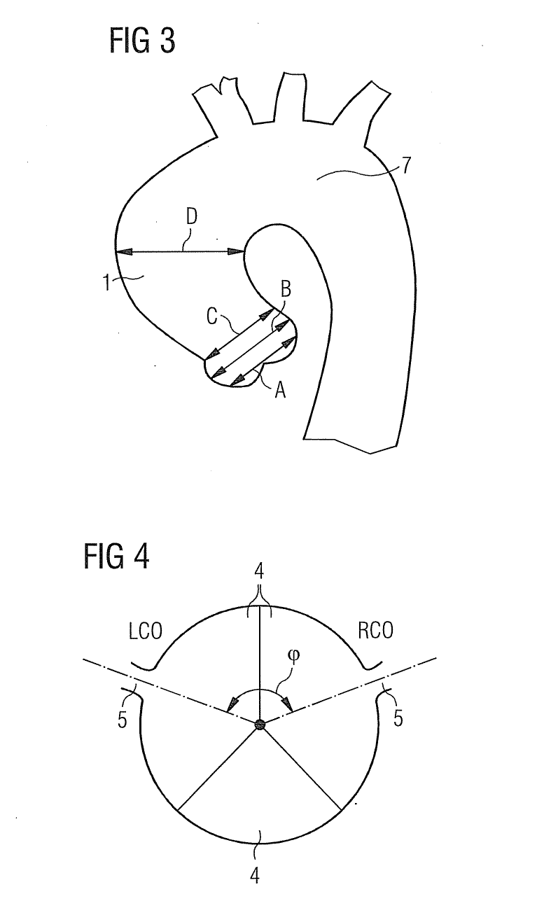

FIG. 3 shows a schematic representation of a part of the aorta with the aorta annulus, the aortic valves, the aorta ascendens 1 as well as the aortic arch 7. The diameters A-D, which are determined by the determination module of the present device from the segmented dataset are shown in this Figure. These dimensions involve the diameter at the aorta annulus plane (A), the maximum diameter in the area of the sinus valsalvae (B), the diameter in the area of the sinotubular junction (C) and the diameter of the aorta ascendens (D).

The proposed device has a segmentation module which, from the volume datasets made available, first segments the aorta ascendens with the aorta annulus, the aortic valves and the coronary ostia together with the left ventricle. A system of algorithms for precisely imaging the heart anatomy around the aortic valve is already available from the publication (US 2010/0240996 A1) cited above. On the basis of this segmented data or the anatomy model obtained therefrom, the following steps are then carried out.

The optimum angiography projections are automatically determined in order to optimally position the C-arm angiography device during the subsequent intervention for checking the catheter guidance and implantation. This requires an optimum presentation of the aorta valve annulus in order to correctly place the heart valve and also of the coronary ostia. The optimum presentation is primarily produced by two factors: the optimum positioning of the prosthesis during the intervention requires an alignment of the C-arm to the annulus plane which is as orthogonal as possible in order to enable the correct location of the stent along the aorta to be determined on the projection image. In addition it is important for the operator to position the C-arm within the intervention room outside the working area if possible.

Accordingly the algorithm finds optimum angulation candidates for the C-arm based on the automatically determined aorta annulus plane. The three detected angle points (points 6 in FIG. 2) of the aortic valve cusp determine the annulus plane. The algorithm calculates different angulations which, perpendicular to the monitor display or the observer, present the aorta annulus plane in profile. The optimum candidates can then be selected within a search area given by the operator. In addition to these angulations it is possible to find an optimum angulation for the presentation of the coronary artery exits, in that the center line between the two coronary ostia lies in parallel to the image plane.

This optimum angulation can likewise be determined by the determination module and output by the output module. To this end FIG. 5 shows a schematic diagram of a C-arm x-ray device, in which the x-ray tube 8 and the x-ray detector 9 are attached to a C-arm 10. The C-arm is able to be rotated in an orbital and axial direction, as is indicated in the figure by the arrows. The data determined by the determination module and output by the output module include the optimum orbital and axial position of the C-arm, so that the projection axis 11 is aligned for observing an implantation at the optimum angle 12 to the system axis 12 and at the optimum axial angle of rotation when a heart valve is inserted into a patient is supported on the patient support table 14.

Furthermore the already mentioned diameters A-D are automatically determined on the basis of their anatomical location. The diameters are calculated from the contours which result from the section of the corresponding planes and the model of the aorta root. The planes are determined by automatically detected landmarks. The automatic segmentation of the route and the detection of the landmarks are described in greater detail in the publication already cited above, the contents of which is included to this end in the present patient application. If a multiphase data record (the complete heart cycle) is available, the determination module automatically determines over the entire heart cycle the respective minimum, maximum and mean diameters A-D. Should only one heart phase be available, which as a rule is the diastolic phase, the determination of these diameters is automatically only carried out in this phase.

Furthermore the two perpendiculars, starting from the lower edge of the coronary ostia (left and right) are dropped onto the annulus plane and the corresponding distances are determined. If a multiphase dataset is available, the respective minimum maximum and mean distances of the perpendiculars to the annulus plane are determined automatically over the entire heart cycle. Since valves and ostia can move relative to one another over the heart cycle, the evaluation of multiphase datasets is of advantage for a reliable determination of a suitable heart valve.

Furthermore the angle φ between the two exits of the coronary arteries is automatically determined by the determination module in this example. The angle which describes the location of the two coronary ostia is relevant for the correct positioning of the artificial heart valve around its vertical axis (rotation). With the incorrect rotational orientation the result can otherwise be that the artificial valves cover the ostia. The angle of the ostia is relevant for the correct placing of the artificial valve, depending on whether the artificial heart valve involves a bicuspid valve or a tricuspid valve.

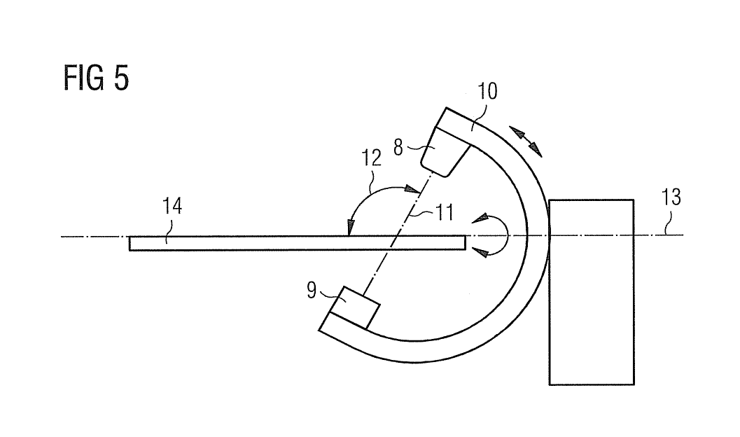

The angle is determined in a plane orthogonal to the aorta ascendens at the height of the coronary ostia. The two points which span the angle starting from the center line of the aorta in this plane are produced by the crossing points of the aorta in a surface (epithel) with the two coronary center lines of the coronary arteries. This is illustrated on the basis of FIG. 4, whose angles show the angles of the coronary ostia to one another. Since complementary angles are involved it is sufficient to specify one of the possible angles. By subtracting this angle from 360° the complementary angle is calculated in each case and likewise specified. The corresponding values of the diameters, distances and angles are output by the output module of the device, to a display for example.

In the present example an interrogation module is also provided, which undertakes a database reconciliation with aortic stent manufacturers. The data determined by the determination module is reconciled in this case directly with a database (offline) in a database module present in the device or online in conjunction with external databases. Subsequently one or more appropriate heart valves determined during this process are proposed.

In the present example an automatic filet view of the aorta annulus with the coronary ostia is created and presented on a screen. For a better and more comprehensible representation of the complex anatomy at the implantation location the visualization model provided for this calculates an unwinding of the aorta ascendens with the coronary ostia. This is then presented in the same manner as is already known currently in the area of colonoscopy for the perspective filet view presentation. In this case the anatomy is virtually subjected to a dissection and for improved clarity broadened out into one plane. This presentation is then preferably undertaken in volume rendering (VR) and surface rendering (SSD) technique. With multiphase datasets, the dissection view can also be separately calculated and then played in a video mode for each heart phase. In addition the measurement points can be traced for the determination of the diameter and perpendiculars shown and their movement traced.

Although the invention has been illustrated and described in greater detail by the exemplary embodiments, the invention is not restricted by the disclosed examples and other variations can be derived herefrom by the person skilled in the art without departing from the scope of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A device for planning a Transcatheter Aortic Valve Implantation (TAVI), in which a transcatheter heart valve is introduced with a catheter into a vessel of a patient and is guided via the vessel to an implantation location, the device comprising:
a segmentation module to, from at least one volume dataset of the heart which was recorded with an imaging method, segment data of at least the left ventricle, the aorta ascendens with aorta annulus, aortic valves and coronary ostia of a heart of the patient;
a determination module to determine, from the segmented data, the aorta annulus plane and to establish, from the determination, one or more angiography projections for setting an angiography device, with which the aorta annulus and the coronary ostia are detectable in a manner for a positioning of the transcatheter heart valve; and
an output module to output at least one of the following for setting the angiography device
the one or more angiography projections established by the determination module,
angulations, and
setting data derived therefrom.

2. The device of claim 1, wherein the determination module is embodied to determine, from the segmented data, the following values based on their anatomical location:
at least one of a respective effective, minimum, and maximum diameter of the aorta in the aorta annulus plane; and
perpendicular distances from lower edges of the coronary ostia to the aorta annulus plane,
wherein the output module is embodied to output at least one of the values and designations of transcatheter heart valves which are suitable for an implantation on the basis of the values determined by the determination module determined by the determination module.

3. The device of claim 2, wherein the determination module is embodied to determine the following values from the segmented data on the basis of their anatomical location:
a diameter of the aorta in a relatively widest area the sinus valsalvae,
a diameter of the aorta in an area of a sinotubular junction and
a diameter of the aorta in an aorta ascendens.

4. The device of claim 2, further comprising:
an interrogation module to, on the basis of values determined by the determination module, establish from one or more databases with data about transcatheter heart valves, one or more transcatheter heart valves suitable for the implantation and to provide the one or more transcatheter heart valves to the output module.

5. The device of claim 2, wherein the determination module is embodied to determine, as a further value, an angle at which center lines of the coronary ostia lie in relation to one another in a sectional plane at right angles to the aorta.

6. The device of claim 2, wherein the determination module is embodied to, with multiphase volume datasets of the heart, determine as respective values, at least one of an effective, minimum and maximum diameter of the aorta over the entire heart cycle.

7. The device of claim 2, wherein the determination module is embodied to, with multiphase volume datasets of the heart, determine as respective values, a minimum, maximum and mean perpendicular distance from the lower edges of the coronary ostia to the aorta annulus plane over the entire heart cycle.

8. The device of claim 1, further comprising:
a visualization module, to create a filet view of the aorta annulus with the coronary ostia from the segmented data and to present the created filet view on a screen.

9. The device of claim 8, wherein the visualization module is embodied to, with multiphase volume datasets of the heart, for each heart phase, create a filet view of the aorta annulus with the coronary ostia from the segmented data and to present the created filet views in a time sequence in a video mode on a screen.

10. The device of claim 3, further comprising:
an interrogation module to, on the basis of values determined by the determination module, establish from one or more databases with data about transcatheter heart valves, one or more transcatheter heart valves suitable for the implantation and to provide the one or more transcatheter heart valves to the output module.

11. The device of claim 3, wherein the determination module is embodied to determine, as a further value, an angle at which center lines of the coronary ostia lie in relation to one another in a sectional plane at right angles to the aorta.

12. The device of claim 3, wherein the determination module is embodied to, with multiphase volume datasets of the heart, determine as values in each case at least one of an effective, minimum and maximum diameter of the aorta over the entire heart cycle.

13. The device of claim 2, further comprising:
a visualization module, to create a filet view of the aorta annulus with the coronary ostia from the segmented data and to present the created filet view on a screen.

14. The device of claim 13, wherein the visualization module is embodied to, with multiphase volume datasets of the heart, for each heart phase, create a filet view of the aorta annulus with the coronary ostia from the segmented data and to present the created filet views in a time sequence in a video mode on a screen.
